(19) United States
(12) Patent Application Publication
(10) Pub. No.: US 2003/0024099 A1
(43) Pub. Date: Feb. 6, 2003

(54) Method for manufacturing shaft member and method for manufacturing dynamic pressure bearing device

(76) Inventor: Masato Gomyo, Suwa-gun (JP)

Correspondence Address: HOGAN & HARTSON L.L.P., 500 S. GRAND AVENUE, SUITE 1900, LOS ANGELES, CA, 90071-2611, US

(21) Appl. No.: 10/209,326

(22) Filed: Jul. 30, 2002

(30) Foreign Application Priority Data
Aug. 3, 2001 (JP) 2001-236392

(51) Int. Cl. B23P 11/00; B23P 17/00

(52) U.S. Cl. 29/525.01

(57) ABSTRACT

A method for manufacturing a dynamic pressure bearing device is provided. The dynamic pressure bearing device includes a bearing member and a shaft member rotatably disposed with respect to one another, and a thrust plate mounted on the shaft member and a counter plate fixed to the bearing member disposed opposite to one another to compose a thrust dynamic pressure bearing section. According to the method, a through hole that communicates with both ends of the shaft member in an axial direction thereof is formed in the shaft member, and a female screw section is formed in an inner wall section of the through hole such that screw members can be screwed from the both ends of the through hole of the shaft member. One of the screw members is screwed in the through hole of the shaft member from one end of the shaft member. The screw member has a screw head section and a male screw section extending from the screw head section for threaded engagement with the female screw section. Prior to screwing the screw member in the through hole of the shaft member, the thrust plate is interposed in the axial direction between the screw head section of the screw member and the one end of the shaft member, and the thrust plate is fixed to the shaft member by tightening the screw member. An adhesive is injected to fill gaps in a screw engagement section between the male screw section of the screw member and the female screw section of the shaft to prevent lubrication fluid from leaking through the screw engagement section, wherein the adhesive has a viscosity of 5 Pa·s or higher after the coating.

### FIELD OF THE INVENTION

The present invention relates to a method for manufacturing shaft members and a method for manufacturing dynamic pressure bearing devices, in both of which another member is affixed to the shaft member.

### DESCRIPTION OF RELATED ART

In general, various types of member are fixed to shafts in a variety of devices. For example, in a dynamic pressure bearing device used in a hard disk drive (HDD) device, such as the one shown in FIG. 10, a rotary shaft (a shaft member) 2 is inserted into a bearing sleeve (bearing member) 1, which is the fixed member, in a freely rotatable manner, and radial bearing sections RB in two places separated in an axial direction are formed by having a lubricating fluid such as an oil injected into a minuscule gap between the inner circumference surface of the bearing sleeve 1 and the outer circumference surface of the rotary shaft 2.

The lubricating fluid is filled continuously from the radial bearing sections RB into a gap between one of the two end surfaces in the axial direction of a thrust plate 3, which has been joined to the rotary shaft 2 through such fixing means as a press fit or a shrink fit, and the bearing sleeve 1, and into a gap between the other end surface in the axial direction of the thrust plate 3 and a counter plate 4 that is attached to the bearing sleeve 1 such that thrust bearing sections SBa and SBb are formed in the axial direction at two places on the top and bottom surfaces of the thrust plate 3.

A rotary hub 6, which holds recording disks 5, is joined to the rotary shaft 2 through a press fit or a shrink fit, while a damper 9 is fixed onto the top end part of the rotary shaft 2 by a screw member 8, and the pressing force of the damper 9 in the axial direction holds the recording disks 5 in place. More specifically, a male screw section 8b that extends from a screw head section 8a of the screw member 8 is screwed into a female screw section 2a formed in the rotary shaft 2, such that the damper 9 is fixed by having the screw head section 8a of the screw member 8 come into contact under pressure with the damper 9 through the tightening force of the screw member 8.

However, in recent years, there has been a trend for the height of dynamic pressure bearing devices to be significantly restricted in the axial direction as the demand for thinner devices grew, which has led to a reduction in the joining length in the axial direction of the thrust plate 3 to the rotary shaft 2, which in turn has led to a risk of declining bonding strength of the thrust plate 3. A reduction in the bonding strength of the thrust plate 3 is becoming a major issue, especially in devices such as mobile devices whose uses are premised upon portability that require sufficient impact resistance in case such devices are dropped.

Further, the female screw section 2a that is formed in the rotary shaft 2 and used to fix the damper 9 is machined from the top end section of the rotary shaft 2, and the female screw section 2a is formed as a blind hole. That is, the bottom portion of the female screw section 2a is formed as a closed hole bottom section, which makes foreign matters such as swarf more prone to accumulate in the hole bottom section of the female screw section 2a. Once the foreign matters have accumulated in the hole bottom section of the female screw section 2a, they cannot be completely removed even after a cleaning process is performed; and if such foreign matters were to scatter outside while the device is in use, they can, for example, become attached to recording disks, which requires cleanliness, thereby possibly causing fatal defects such as failure to record and/or reproduce information.

Moreover, as devices become even thinner, the length of the prepared hole of the female screw section 2a formed in the rotary shaft 2 also becomes shortened. When this happens, the female screw section 2a is threaded by a tapping tool. This, however, causes great stress on the tapping tool that makes the tapping tool prone to breaking, which can reduce productivity. This problem also occurs when the thrust plate 3 is provided in the upper section in the axial direction so that the thrust plate 3 is used simply as a fall-out stopper plate for the shaft.

### SUMMARY OF THE INVENTION

In view of the above, the present invention provides a method for manufacturing a shaft member and a method for manufacturing a dynamic pressure bearing device, where both have simple structures, improve the bonding strength of the member to be fixed, such as a thrust plate, and have superior cleanliness and workability.

In accordance with an embodiment of the present invention, a method for manufacturing a shaft member comprises providing in a shaft a through hole that communicates with both ends of the shaft in an axial direction, forming a female screw section in the inner wall section of the through hole, screwing into the through hole of the shaft a screw member with a male screw section that engages the female screw section and that extends from a screw head section, interposing a member to be fixed in the axial direction between the screw head section of the screw member and one end section of the shaft, such that while the member to be fixed is fixed by the tightening force of the screw member, and filling an adhesive to seal gaps in at least one part of a screw engagement section between the male screw section of the screw member and the female screw section of the shaft, wherein the adhesive used has viscosity of 5 Pa·s or higher all times after it is coated.

According to such a method for manufacturing the shaft member, the member to be fixed is firmly fixed by the tightening force of the screw member against the shaft, which greatly increases the bonding strength of the member to be fixed.

Further, due to the fact that the adhesive that seals the gaps in the screwing section is filled in at least one part of the screwing section between the male screw section of the screw member and the female screw section of the shaft, loosening of the screw member is prevented by the adhesive.

The adhesive flows favorably towards the interior of the screwing section to fill it, due to the capillary force and the wetting spreadability that are generated in the screwing section between the male screw section of the screw member and the female screw section of the shaft. In the present invention, the minimum viscosity of the adhesive is appropriately specified, and this restrains a phenomenon, caused by the wetting spreadability, in which the adhesive crawls up along the female screw section of the shaft in a direction opposite to the interior of the screw engaging section. As a result, when a clamp screw member is screwed onto the end section opposite of the member to be fixed, situations in which the clamp screw member cannot be screwed on due to the adhesive's crawling up are favorably avoided.

In the manufacturing method described above, by appropriately specifying the maximum viscosity of the adhesive, the flowability of the adhesive is favorably secured as it is injected, so that the adhesive can be injected very smoothly.

Furthermore in the manufacturing method described above, by using an adhesive with viscosity that allows the adhesive to be filled generally along the entire length of the screwing section of the screw member, the effects described above can be firmly secured.

In accordance with another embodiment of the present invention, a method for manufacturing a dynamic pressure bearing device comprises providing in a shaft member a through hole that communicates in both ends of the shaft in an axial direction, forming a female screw section in the inner wall section of the through hole, screwing into the through hole of the shaft member a screw member with a male screw section that engages the female screw section and that extends from a screw head section, interposing a thrust plate in the axial direction between the screw head section of the screw member and one end section of the shaft member, such that while the thrust plate is fixed by the tightening force of the screw member, and filling an adhesive to prevent a lubricating fluid from leaking outside by sealing gaps in at least one part of a screwing section between the male screw section of the screw member and the female screw section of the shaft member, wherein the adhesive used has viscosity of 5 Pa·s or higher all times after being coated.

According to such a method for manufacturing the dynamic pressure bearing device, the thrust plate is firmly fixed by the tightening force of the screw member against the shaft member, which greatly increases the bonding strength of the thrust plate.

Further, due to the fact that the adhesive that seals the gaps in at least one part of the screwing section is filled in between the male screw section of the screw member and the female screw section of the shaft member to prevent the lubricating fluid from leaking outside, the adhesive seals the lubricating fluid that tries to leak outside through the through hole and prevents the screw member from becoming loose.

The adhesive flows favorably towards the interior of the screwing section to fill it, due to the capillary force and the wetting spreadability that are generated in the screwing section between the male screw section of the screw member and the female screw section of the shaft member. In this embodiment of the present invention, the minimum viscosity of the adhesive is set at 5 Pa·s or higher, and this restrains the phenomenon, caused by the wetting spreadability, in which the adhesive crawls up along the female screw section of the shaft member in a direction opposite to the interior of the screw engaging section. As a result, situations are favorably avoided in which a clamping screw member that is to be screwed onto the end section opposite of the thrust plate of the shaft member cannot be screwed on due to the adhesive's crawling up.

Moreover, in the method for manufacturing the dynamic pressure bearing device, due to the fact that a space section is provided where the thrust plate and the screw member join with each other in order to reduce the capillary force in the screwing section between the screw member and the shaft member and thereby prevent the adhesive from leaking outside, the adhesive is well prevented from leaking outside when it is injected.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 is a longitudinal cross-sectional view illustrating an example of an overall structure of a hard disk drive (HDD) device equipped with a shaft rotation-type dynamic pressure bearing device manufactured applying the present invention.

FIG. 2 is an enlarged, longitudinal cross-sectional view of the screw fixing structure of a thrust plate to a shaft member in the dynamic pressure bearing device shown in FIG. 1.

FIG. 3 shows a structural view illustrating the screw fixing structure in FIG. 2 as seen from the bottom.

FIG. 4 shows an enlarged, bottom view illustrating the thrust plate used in the device indicated in FIGS. 1-3.

FIG. 5 is an enlarged, longitudinal cross-sectional view illustrating the thrust plate used in the device indicated in FIGS. 1-3.

FIG. 6 is a longitudinal cross-sectional view illustrating a state immediately before the adhesive is injected into the interior of the shaft member.

FIG. 7 is a longitudinal cross-sectional view illustrating a state as the adhesive is being injected into the interior of the shaft member.

FIG. 8 is a longitudinal cross-sectional view illustrating a state in which the adhesive that was injected into the interior of the shaft member crawls up due to the wetting spreadability.

FIG. 9 is a line graph showing the results of an experiment in which the change in viscosity (in Pa·s) of an adhesive with temperature as a parameter.

FIG. 10 is a longitudinal cross-sectional view illustrating an example of an overall structure of an HDD equipped with a conventional dynamic pressure bearing device.

### DESCRIPTION OF PREFERRED EMBODIMENTS

An embodiment of the present invention, along with an overall structure of a hard disk drive device (HDD) to which the manufacturing method according to the present invention has been applied, is described in detail below with reference to the accompanying drawings.

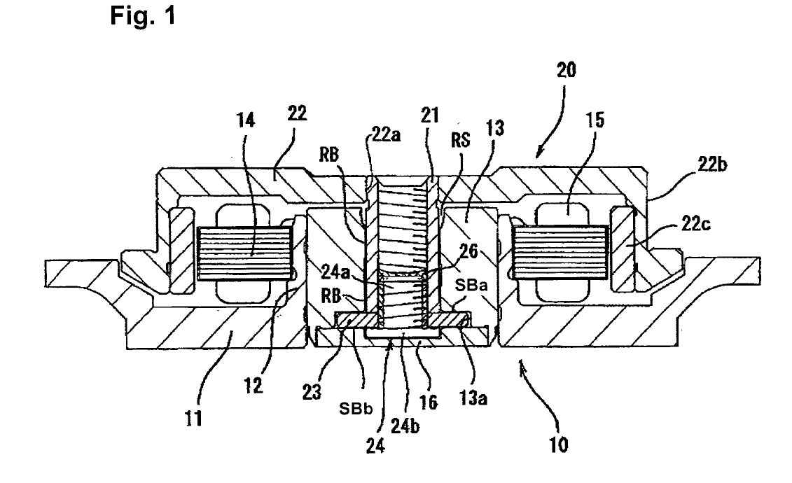

FIG. 1 shows an overall view of a HDD spindle motor of a shaft rotation type. The HDD spindle motor includes a stator assembly 10, which is a fixed member, and a rotor assembly 20, which is a rotating member assembled onto the top of the stator assembly 10. The stator assembly 10 has a fixed frame 11, which is screwed to a fixed base omitted from drawings. The fixed frame 11 is formed with an aluminum material to achieve a lighter weight; on the inner circumference surface of a ring-shaped bearing holder 12 formed upright in the generally center part of the fixed frame 11 is a bearing sleeve 13, which is a fixed bearing member formed in the shape of a hollow cylinder and joined to the bearing holder 12 through a press fit or a shrink fit. The bearing sleeve 13 is formed with a copper material such as phosphor bronze in order to facilitate machining holes with small diameters.

A stator core 14, which is formed from a laminate of electromagnetic steel plates, is mounted on the outer circumference mounting surface of the bearing holder 12. A drive coil 15 is wound around each of the salient pole sections provided on the stator core 14.

A rotary shaft 21 that comprises the rotor assembly 20 is inserted in a freely rotatable manner in a center hole provided in the bearing sleeve 13. This means that a dynamic pressure surface formed on an outer circumference surface of the rotary shaft 21 and a dynamic pressure surface formed on an inner circumference wall section of the bearing sleeve 13 are positioned opposite to each other in a radial direction and in close proximity, and radial dynamic pressure bearing sections RB are formed in the minuscule gap sections between them. More specifically, the dynamic pressure surface on the bearing sleeve 13 side and the dynamic pressure surface on the rotary shaft 21 side of the radial dynamic pressure bearing sections RB are positioned opposite to each other in a circular fashion across a minuscule gap of several μm, and a lubricating fluid such as a lubricating oil is injected or placed in a continuous manner in an axial direction in the bearing space formed by the minuscule gap.

On at least one of the dynamic pressure surfaces of the bearing sleeve 13 or the rotary shaft 21 are radial dynamic pressure generating grooves in a herringbone shape, for example, that are omitted from drawings but concavely formed in a ring shape in two blocks separated in the axial direction. During rotation, a pumping effect of the radial dynamic pressure generating grooves pressurizes the lubricating fluid to generate dynamic pressure, and a rotary hub 22, which is described later, together with the rotary shaft 21 becomes shaft-supported in the radial direction in a non-contact state with respect to the bearing sleeve 13 due to the dynamic pressure of the lubricating fluid.

At the top end of the bearing space that makes up each of the radial dynamic pressure bearing sections RB is formed a capillary sealing section RS. The capillary sealing sections RS is a gap gradually widening towards the outside of the bearing, due to an inclined surface formed on either the rotary shaft 21 or the bearing sleeve 13, and the gap is set from about 20 μm to about 300 μm, for example. The capillary sealing section RS is formed so that the liquid level of the lubricating fluid is in the capillary sealing section RS both when the motor is rotating and when it is stopped, and the lubricating fluid fills the space between the entire bearing surfaces interior of the capillary sealing section RS.

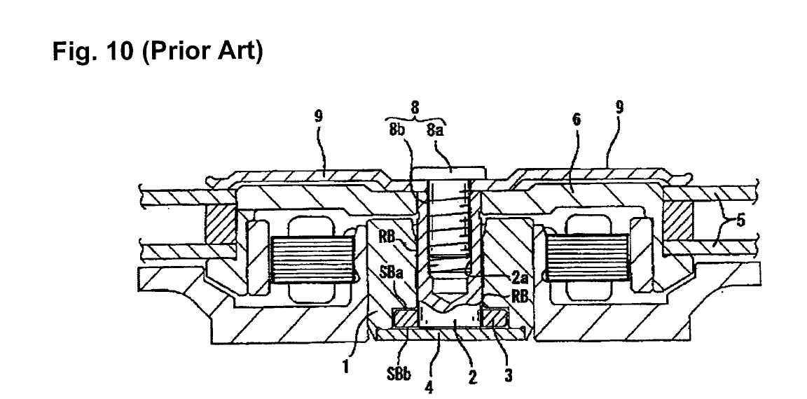

The rotary hub 22 that with the rotary shaft 21 comprises the rotor assembly 20 is a generally cup-shaped member made of an aluminum metal, and a joining hole 22a provided in the center part of the rotary hub 22 is joined in a unitary fashion with the top end part of the rotary shaft 21 through a press fit or a shrink fit. A recording medium such as a magnetic disk is fixed to the rotary hub 22 with a damper (see 9 in FIG. 10), which is omitted from FIG. 1.

The rotary hub 22 has a generally cylindrical-shaped body section 22b, which retains the recording medium disk mounted on its outer circumference section, and a ring-shaped drive magnet 22c on the inner circumference wall surface of the body section 22b towards the bottom thereof as shown in the figure. The ring-shaped drive magnet 22c is positioned in a ring-shaped manner in close proximity to and opposite to the outer circumference end surface of the stator core 14.

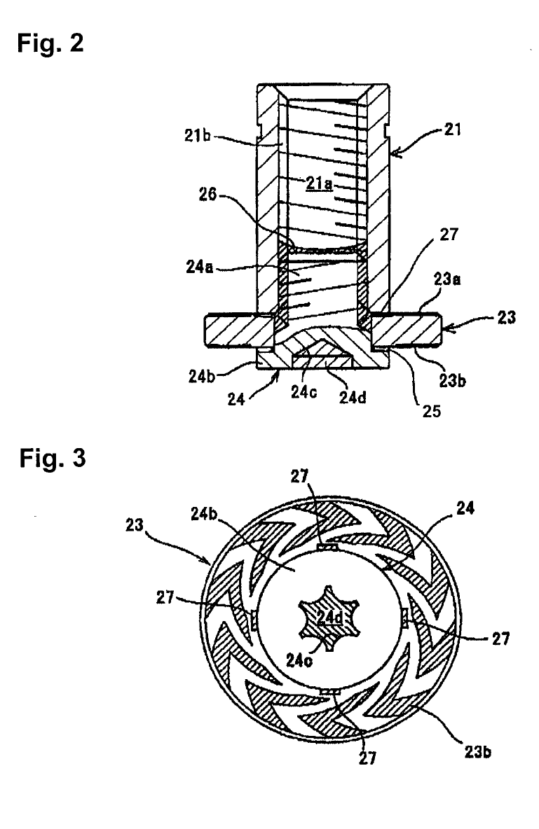

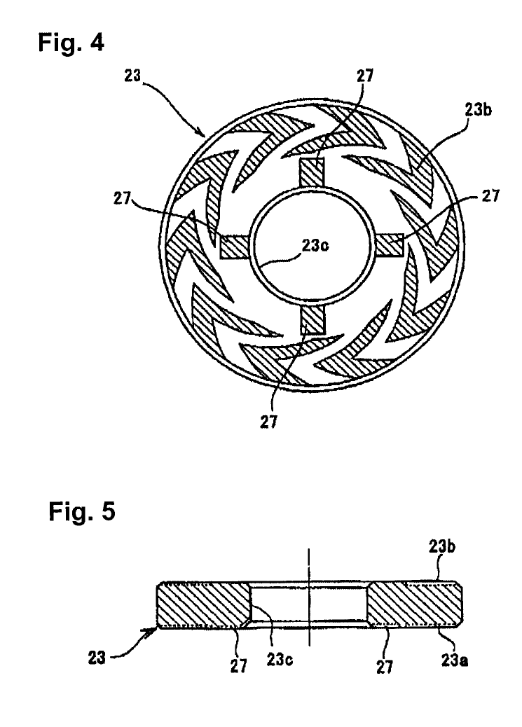

A disk-shaped thrust plate 23 is affixed by a plate fixing screw 24, which is described later, at the bottom end part of the rotary shaft 21, as shown in FIGS. 2-5. The thrust plate 23 is positioned to be contained within a cylindrically shaped depressed section 13a (see FIG. 1), which is concavely formed in the center part of the bearing sleeve 13 towards the bottom, and a dynamic pressure surface on the top surface of the thrust plate 23 is positioned within the depressed section 13a opposite to a dynamic pressure surface of the bearing sleeve 13 in close proximity to each other in the axial direction. On the dynamic pressure surface on the top surface of the thrust plate 23 are formed thrust dynamic pressure generating grooves 23a in herringbone shapes as shown in FIGS. 3 and 4, and a top thrust dynamic pressure bearing section SBa is formed in the gap part between the opposing dynamic pressure surfaces of the thrust plate 23 and the bearing sleeve 13.

A counter plate 16, which is a disk-shaped member with a relatively large diameter, is positioned in close proximity to a dynamic pressure surface on the bottom surface of the thrust plate 23. The counter plate 16 is positioned to close off the opening part at the bottom of the bearing sleeve 13, and the outer circumference part of the counter plate 16 is fixed to the bearing sleeve 13.

Herringbone-shaped thrust dynamic pressure generating grooves 23b are formed on a dynamic pressure surface on the bottom surface of the thrust plate 23 as shown in FIGS. 3 and 4, whereby a bottom thrust dynamic pressure bearing section SBb is formed.

The two dynamic pressure surfaces of the thrust plate 23 and the respective opposing dynamic pressure surface of the bearing sleeve 13 and of the counter plate 16 thus form a set of thrust dynamic pressure bearing sections SBa and SBb that are positioned adjacent to each other in the axial direction; each opposing set of dynamic pressure surfaces are positioned opposite to each other in the axial direction across a minuscule gap of several μm. The lubricating fluid such as oil is poured or placed, until its liquid level is in the capillary sealing section RS, in the bearing spaces consisting of the minuscule gaps in a continuous manner in the axial direction through a pathway on the outer circumference of the thrust plate 23. During rotation, a pumping effect caused by the thrust dynamic pressure generating grooves 23a and 23b provided on the thrust plate 23 pressurizes the lubricating fluid to generate dynamic pressure; and the dynamic pressure of the lubricating fluid causes the rotary shaft 21 and the rotary hub 22 to be shaft-supported in the thrust direction in a floating, non-contact state with respect to the bearing sleeve 13.

A through hole 21a is formed in the rotary shaft 21 along the center axis of the rotary shaft 21, and the through hole 21 a communicates both the top and bottom ends of the rotary shaft 21 in the axial direction. On a cylindrical inner circumference wall section of the through hole 21a is formed a female screw section 21b, and a clamp fixing screw, omitted from drawings (see 8 in FIG. 10), is screwed into the top end of the female screw section 21b. A screw head section of the clamp fixing screw is positioned to come into contact, under pressure that it applies from above, with a damper (see 9 in FIG. 10) used to fix a disk, and the tightening force of the clamp fixing screw fixes the clamper.

If the recording medium such as a magnetic disk that is held by the damper turns counterclockwise as seen from the top in FIG. 2, the female screw section 21b is formed as a right-handed screw, while if the recording medium such as a magnetic disk turns clockwise as seen from the top in FIG. 2, the female screw section 21b is formed as a left-handed screw. This is to prevent the clamp fixing screw from becoming loose by the torque generated when the motor begins to turn.

In FIG. 2, a plate fixing screw 24, which serves as a screw member to fix the thrust plate 23, is screwed at the bottom end of the female screw section 21b that is formed in the inner circumference wall section of the through hole 21 a of the rotary shaft 21. The plate fixing screw 24 has a male screw section 24a that engages the female screw section 21b of the rotary shaft 21, and the male screw section 24a is provided to project in the axial direction upward from a screw head section 24b of the plate fixing screw 24. By having the male screw section 24a of the plate fixing screw 24 inserted into the through hole 21a of the rotary shaft 21 from the bottom and screwed onto the female screw section 21b, the screw head section 24b comes into contact under pressure with the bottom end of the thrust plate 23 in FIG. 2.

As a result, the thrust plate 23 is interposed in the axial direction between the screw head section 24b of the plate fixing screw 24 and the bottom end surface of the rotary shaft 21, and the thrust plate 23 becomes fixed when the plate fixing screw 24 is tightened in this state.

A washer 25 is interposed between the screw head section 24b of the plate fixing screw 24 and the thrust plate 23. The washer 25 serves to eliminate foreign matters such as burr that can be produced as a result of a cutting phenomenon that occurs when the plate fixing screw 24 is tightened, and for this reason a metallic washer with high hardness and smoothness or a washer made of resin such as PTFE or PEEK is used as the washer 25.

Nearly along its entire length, a screw engaging section between the male screw section 24a of the plate fixing screw 24 and the female screw section 21b of the rotary shaft 21 is filled with an oil-resistant adhesive 26, such as epoxy resin. The adhesive 26 is injected so as to make its way into gaps in the screw engaging section of the plate fixing screw 24, filled so as to cover the tip section of the plate fixing screw 24, and filled as a member to seal the through hole 21a in the axial direction. In other words, the adhesive 26 completely prevents the lubricating fluid from leaking outside and stops the plate fixing screw 24 from becoming loose. Acrylic resins that easily react with oil are not desirable as an adhesive in this invention, due to their possible interaction with the lubricating fluid.

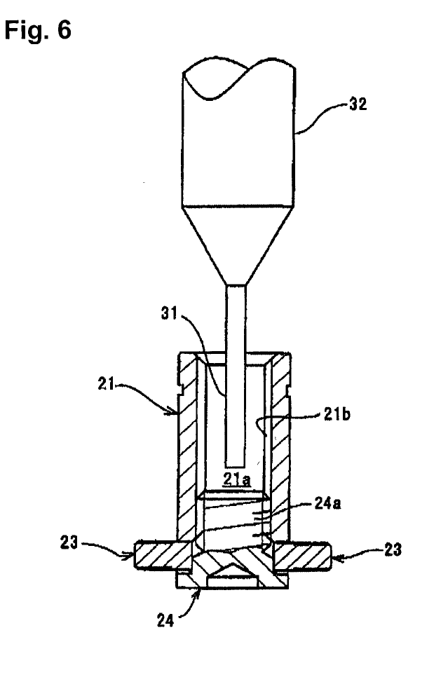

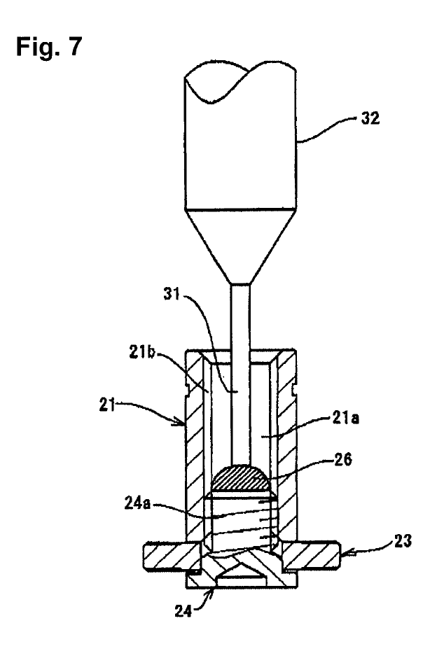

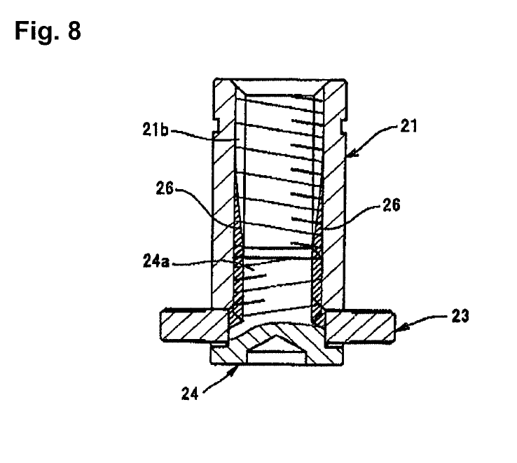

The adhesive 26 is injected into the interior of the through hole 21a via the opening section on the damper mounting side shown in FIG. 2 at the top end of the through hole 21a provided in the rotary shaft 21, with the opening of the through hole 21a facing up as shown in FIGS. 6 and 7. The air in the internal space of the continuous hole 21a that is pressurized when the adhesive 26 is injected travels through air vent pathways 27, which are space sections provided in a groove shape at the bottom end part of the rotary shaft 21 in FIG. 2, and becomes discharged towards the outer side in the radial direction of the rotary shaft 21.

In one embodiment, for example, the air vent pathways 27 are concave grooves concavely formed at four locations in a circumferential direction at the part where the thrust plate 23 abuts against the bottom end section of the rotary shaft 21 in FIG. 2. Each of the air vent pathways 27 extends outward in the radial direction from the inner circumference rim section of a center hole section 23c of the thrust plate 23 and is formed to extend outward beyond the outer conference surface ofthe rotary shaft 21, so that air can escape through its concave section. And the internal space of the through hole 21a, which is formed between the part where the thrust plate 23 abuts the bottom end section of the rotary shaft 21 and the part where the adhesive 26 is filled, communicates to the outer side of the rotary shaft 21 through each of the air vent pathways 27.

As described above, the adhesive 26 is injected as indicated in FIGS. 6 and 7, for example. In other words, first the rotary shaft 21 on which the thrust plate 23 has been fixed is set on an appropriate jig so that the opening section of the damper mounting side (top end) of the rotary shaft 21 faces up. Next, as shown in FIG. 6, an adhesive coating needle 31 with an appropriate inner diameter is inserted into the continuous hole 21a of the rotary shaft 21 along the axial direction, and taking care not to let it come into contact with the female section 21b, when the adhesive coating needle 31 reaches a position an appropriate distance away from the male screw section 24a of the plate fixing screw 24, the adhesive 26 is delivered from the tip section of the adhesive coating needle 31 and a fixed amount of the adhesive is coated, as shown in FIG. 7.

When this happens, the adhesive coating needle 31 is mounted on a main body cylinder section 32, and a pneumatic dispenser connected to the main body cylinder section 32 supplies the adhesive 26. A desired amount of coating is obtained by appropriately managing and controlling the air pressure of the dispenser, as well as the coating temperature and coating time of the adhesive 26.

A two-part epoxy adhesive may be used as the adhesive 26 in this embodiment. The two-part epoxy adhesive involves mixing and stirring a main agent and a hardening agent immediately before coating. Although the two-part epoxy adhesive hardens even when it is allowed to stand at room temperature, since this requires a long time for it to harden completely, heat is applied after coating, as described later.

However, in high temperature environment, although the hardening time of the adhesive is shortened, the viscosity falls so that the flowability increases; consequently, the wetting and spreading effect makes the adhesive prone to flowing along valley sections of the female screw section 21b of the rotary shaft 21. That is, when an adhesive with low viscosity that is readily flowable is used, there is more occurrence of a phenomenon in which the adhesive 26 travels along and crawls up the valley sections of the female screw section 21b of the rotary shaft 21 upward in a direction opposite to the screw engaging section of the plate fixing screw 24, and once the adhesive 26 crawls up above a certain position, the clamp fixing screw (see 8 in FIG. 10) that is to be screwed on the top end of the rotary shaft 21 cannot be screwed.

In view of this, even in the post-coating heating process that lasts until the adhesive 26 hardens, conditions are established so that the viscosity of the adhesive 26 is equal to or higher than a predetermined value. By specifying that the adhesive to be used has an appropriately high viscosity, the adhesive can be allowed to flow favorably into the screw engaging section between the male screw section 24 of the plate fixing screw 24 and the female screw section 21b of the rotary shaft 21, while at the same time the volume and/or the height that the adhesive 26 crawls up along the valley sections of the female screw section 21b upward in a direction opposite to the screw engaging section can be restricted within an allowable range. Consequently, the clamp fixing screw can be screwed on smoothly at the top end of the rotation shaft 21 without being hindered by the adhesive.

In other words, the property required in injecting the adhesive 26 is that its viscosity, even in the post-coating heating process, is established so that the adhesive 26 flows smoothly into the screw engaging section of the plate fixing screw 24, but the volume and/or height that the adhesive 26 crawls up in the opposite direction along the valley sections of the female screw section 21b of the rotary shaft 21 do not increase beyond the predetermined allowable ranges. With this in mind, adhesives whose viscosity after coating is 5 Pa·s or higher, even during the heating process, are used in this invention, as a result of conducting the following experiment.

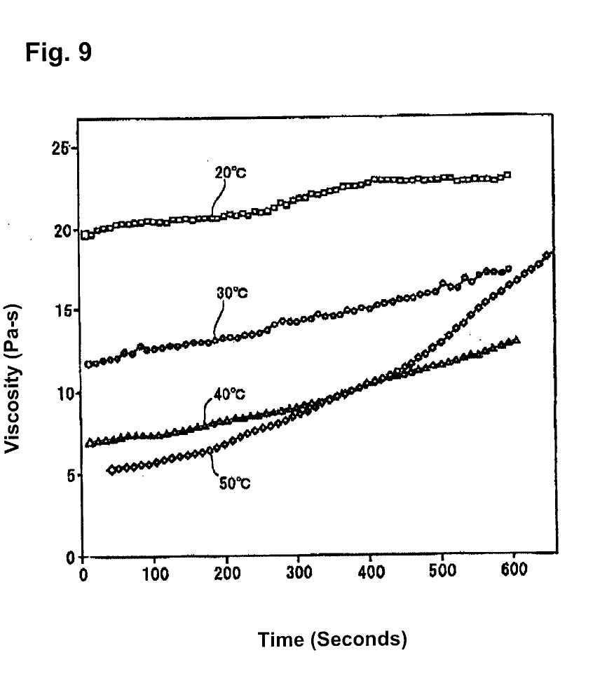

First, to explain the results of measuring the viscosity changes of adhesive, the temperature of the adhesive, which was the test subject, was varied between 20° C. and 50° C. at a 10° C. interval. The viscosity changes of each of the adhesive at various temperatures are indicated in FIG. 9, which shows on the x-axis time elapsed (in seconds) after the main agent and the hardening agent of the epoxy resin adhesive were mixed and on the y-axis the viscosity of the adhesive (in Pa·s). When the adhesive at various temperatures and with the viscosity property indicated was coated on actual devices, the following was found:

(1) When an adhesive whose viscosity after coating was 6 Pa·s when the adhesive's temperature was 40° C. was used, the crawl up phenomenon of the adhesive was somewhat below the upper limit of the allowable range, which means that this adhesive was favorably usable.

(2) When an adhesive whose viscosity after coating was 5 Pa·s when the adhesive's temperature was 50° C. was used, although the crawl up phenomenon of the adhesive approached the upper limit of the allowable range, this adhesive was found to be in the usable range.

(3) When an adhesive's temperature is 22° C., the adhesive's viscosity is approximately 18 Pa·s calculating backwards from the viscosity data; it was found that an adhesive whose viscosity is three times this, i.e., 54 Pa·s, flows smoothly into the screw engaging section of the plate fixing screw 24 and has a good sealing function.

(4) When the viscosity of adhesives was less than 5 Pa·s, the crawl up phenomenon of the adhesives was observed and there were problems in screwing on the clamping screw member.

Based on these experiment results, it was found that the crawl up phenomenon of the adhesive can be restricted within the allowable range if the lower limit of the viscosity of the adhesive 26 is set at 5 Pa·s or higher all times after being coated, and during heating process.

In other words, when the adhesive's temperature is 50° C. or higher during the heating process, the property of the adhesive must be set so that the lower limit value of the viscosity during the process is 5 Pa·s or higher. Or, when using an adhesive based on the experiment results, the adhesive's temperature must be 50° C. or lower during the heating process. Or, as shown in FIG. 9, since viscosity increases with time, the heating process can begin at 40° C. and the heating temperature can be raised subsequently, taking into consideration the viscosity so that the viscosity remains 5 Pa·s or higher.

On the other hand, there is basically no need to be concerned about the upper limit value of the viscosity of the adhesive 26. This is due to the fact that even if an adhesive with a relatively high viscosity were to be used, it is relatively easy to fill the adhesive 26 into the screw engaging section of the plate fixing screw 24 due to the capillary force and the wetting spreadability that are generated in the screw engaging section. However, it is desirable to establish the upper limit value for the viscosity of the adhesive 26 low enough that the adhesive 26 can be filled generally along the entire length of the screw engaging section of the plate fixing screw 24 and that it has appropriate flowability.

Further concerning the upper limit value of the viscosity of the adhesive 26, workability in injecting the adhesive 26 using the adhesive coating needle 31 must be taken into consideration. That is, if the viscosity of the adhesive 26 is so high that its flowability has fallen considerably, the adhesive 26 is not delivered smoothly from the adhesive coating needle 31. Consequently, in the present invention, the adhesive 26 with a viscosity of 25 Pa·s or lower after coating is used, so that the adhesive 26 has a sufficient flowability and therefore can be injected smoothly and reliably. In other words, the adhesive 26 may preferably have a viscosity of 25 Pa·s or lower during coating and at least until the adhesive 26 sufficiently spreads along the entire length of the screw engaging section of the plate fixing screw 24, and heating of the adhesive is started for thermosetting the same.

In relation further to the injection of the adhesive 26, in the present embodiment, the air vent pathways 27 comprising space sections, which are provided where the thrust plate 23 abuts against the bottom end section of the rotary shaft 21 in FIG. 2, are formed as described earlier, and these air vent pathways 27 somewhat reduce the capillary force in the screw engaging section of the plate fixing screw 24. Consequently, the air vent pathways 27 work as space sections to prevent the adhesive 26 from leaking outside.

The viscosity of the two-part epoxy resin adhesive that is used in the present embodiment increases gradually with time, but its viscosity can also decline with time depending on the heat of reaction during hardening. When this happens, the minimum viscosity should be established within the desired range.

After coating a predetermined amount of the adhesive 26 in this way, a heating and hardening processing of the adhesive 26 takes place. The device is placed inside a constant-temperature oven with the opening section of the damper mounting side at the top end of the through hole 21a of the rotary shaft 21 facing upward, the temperature of the constant-temperature oven is set so that the viscosity of the adhesive would be the desired viscosity, and the adhesive 26 is heated and hardened. After the adhesive 26 is completely hardened, organic matters attached to the surface of the adhesive 26 are baked at a temperature equal to or lower than Tg (e.g., 80° C.-100° C.) in order to remove gas components produced from the adhesive 26. Such processing is commonly called a stepped-cure process.

In the present embodiment, there is a tool engaging concave section 24c, which is flat, star-shaped and used to tighten a screw, in the axial center part on the outer surface of the screw head section 24b of the plate fixing screw 24, as shown especially in FIGS. 2 and 3. The tool engaging concave section 24c is concavely formed so that its cross-section surface depresses in a generally triangular shape, and an oil-resistant adhesive 24d is filled into the tool engaging concave section 24c after the screw is tightened. The adhesive 24d serves to contain foreign matters such as burr that can be produced in the tool engaging concave section 24c as a result of a cutting phenomenon when the plate fixing screw 24 is tightened, and the adhesive 24d prevents the foreign matters such as burr from flowing or scattering outside.

In the present embodiment having such a structure, by having the plate fixing screw 24 tightened against the rotary shaft 21, the thrust plate 23 is firmly fixed. Consequently, the bonding strength of the thrust plate 23 is significantly improved over conventional press fit. Further in the present embodiment, due to the fact that the through hole 21a is formed in order to form the female screw section 21b in the rotary shaft 21, a prepared hole with the maximum length in the axial direction is provided. And on the prepared hole comprising the maximum length through hole 21a, the female screw section 21b is easily and efficiently machined since a threading tool having a machining length with margin is used for this purpose. Furthermore, foreign matters such as swarf that are produced when the female screw section 21b is machined are easily discharged outside through the opening section of the through hole 21a, which allows favorable cleanliness to be obtained.

Additionally in the present embodiment, due to the fact that the adhesive 26 is filled in the screw engaging section between the male screw section 24a of the plate fixing screw 24 and the female screw section 21b of the rotary shaft 21 to seal the gaps in the screw engaging section and to prevent the lubricating fluid from leaking outside, the adhesive 26 seals the lubricating fluid that is prone to flowing outside through the through hole 21a and firmly prevents the plate fixing screw 24 from becoming loose.

In injecting the adhesive 26, the capillary force and the wetting spreading effect in the screw engaging section between the male screw section 24a of the plate fixing screw 24 and the female screw section 21b of the rotary shaft 21 cause the adhesive 26 to be filled smoothly into the screw section. Due to the fact that the minimum viscosity of the adhesive 26 is appropriately specified (i.e., set at 5 Pa·s or higher) in the present embodiment, the phenomenon, caused by the wetting spreadability, in which the adhesive 26 crawls up along the valley sections of the female screw section 21b of the rotary shaft 21 upward in the direction opposite to the screw engaging section is restrained. As a result of this, situations can be avoided in which the clamp fixing screw that is to be screwed on at the end opposite the thrust plate 23 cannot be screwed on due to the adhesive 26's crawling up.

Due to the fact that the maximum viscosity of the adhesive 26 is appropriately specified (i.e., set at 25 Pa·s or lower) in the present embodiment as least during injection of the adhesive 26, the flowability of the adhesive 26 when it is injected is favorably secured, ensuring an extremely smooth injection of the adhesive 26.

In addition, due to the fact that the air vent pathways 27, which are space sections provided where the thrust plate 23 and the plate fixing screw 24 join, reduce the capillary force in the screwing section between the plate fixing screw 24 and the rotary shaft 21 and thereby prevent the adhesive 26 from leaking outside, the adhesive 26 is favorably prevented from leaking outside when it is injected in the present embodiment.

Although embodiments of the present invention by the inventor have been described above in some variations, needless to say, many modifications can be made without departing from the present invention.

For example, in the embodiment described above, the thrust bearing section comprises the thrust plate 23, but the present invention can be similarly applied even when the thrust bearing section is formed between the top surface of the bearing sleeve 13 and the bottom surface of the rotary hub 22 and the thrust plate 23 is used merely as a fall-out stopper in the thrust direction.

Although in the embodiment described above, the present invention is applied to a rotary shaft-type dynamic pressure bearing device, the present invention can be similarly applied to fixed shaft-type dynamic pressure bearing devices.

Furthermore, the present invention is similarly applicable to dynamic pressure bearing devices used in various types of devices, such as polygon mirror drive motors or CD-ROM drive motors, in addition to dynamic pressure bearing devices used in HDD motors, as described in the embodiment.

As described above, the method for manufacturing a shaft member according to the present invention comprises providing in a shaft a through hole with a female screw section that is formed from a prepared hole having a maximum length in the axial direction, interposing a member to be fixed between a screw head section of a screw member to be screwed into the female screw section of the through hole and one end section of the shaft, tightening the member to be fixed with the screw member to fix the member to be fixed to the shaft, and appropriately controlling the minimum viscosity of an adhesive that significantly improves the bonding strength of the member to be fixed and seals gaps in the screwing section between the screw member and the shaft. As a result, the shaft member having the structure described above restrains a phenomenon in which the adhesive crawls up along the female screw section of the shaft in a direction opposite to the screw engaging section of the screw member, so that the screw member can be effectively screwed into the shaft from the end section opposite of the member to be fixed. Consequently, the manufacturing method with a simple structure can improve the reliability of the shaft's strength, its cleanliness and its workability.

Further in the present embodiment, by appropriately specifying the maximum viscosity of the adhesive, the flowability of the adhesive, when it is injected, is favorably secured, so that the adhesive can be injected very smoothly, thereby improving the productivity of dynamic pressure bearing devices.

Moreover, the method for manufacturing a dynamic pressure bearing device according to the present invention comprises providing in a shaft member a through hole with a female screw section that is formed from a prepared hole having a maximum length in the axial direction, interposing a thrust plate between a screw head section of a screw member to be screwed into the female screw section of the through hole and one end section of the shaft member, tightening and fixing the thrust plate with the screw member to the shaft, and appropriately controlling the minimum viscosity of an adhesive that significantly improves the bonding strength of the thrust plate and seals gaps in the screwing section between the screw member and the shaft member. As a result, the dynamic pressure bearing device having the structure described above restrains a phenomenon in which the adhesive crawls up along the female screw section of the shaft member in a direction opposite to the screw engaging section of the screw member, so that the screw member can be favorably screwed into the shaft member from the end section opposite of the thrust plate. Consequently, the manufacturing method with a simple structure can improve the reliability of the dynamic pressure bearing device's strength, its cleanliness and its workability.

Moreover, the method for manufacturing a dynamic pressure bearing device in accordance with an embodiment of the present invention, space sections where the thrust plate and the screw member join are provided in order to reduce the capillary force of the screwing section between the screw member and the shaft member and thereby prevent the adhesive from leaking outside. This structure effectively prevents the adhesive from leaking outside when it is injected. Consequently, in addition to the effects described above, a spill-over of the adhesive is eliminated, which improves the reliability of the dynamic pressure bearing device.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for manufacturing a shaft member, the method comprising:
forming in a shaft a through hole that communicates with both ends of the shaft in an axial direction of the shaft;
forming a female screw section in an inner wall section of the through hole;
screwing into the through hole of the shaft a screw member with a screw head section and a male screw section extending from the screw head section for threaded engagement with the female screw section;
interposing a member in the axial direction between the screw head section of the screw member and one end section of the shaft; and
fixing the member to the shaft by tightening force of the screw member.

2. A method for manufacturing a shaft member according to claim 1, further comprising coating an adhesive to fill gaps in at least one part of a screw engagement section between the male screw section of the screw member and the female screw section of the shaft, wherein the adhesive has a viscosity of 5 Pa·s or higher all times after the coating.

3. A method for manufacturing a shaft member according to claim 2, wherein the adhesive has a viscosity of 25 Pa·s or lower at least during the coating.

4. A method for manufacturing a shaft member according to claim 2, wherein the adhesive has a viscosity that allows the adhesive to spread along substantially an entire length of the male screw section of the screw member.

5. A method for manufacturing a shaft member according to claim 1, further comprising holding the shaft generally vertically upright, and injecting the adhesive in the through hole of the shaft through a top opening section of the through hole of the shaft.

6. A method for manufacturing a shaft member according to claim 5, further comprising inserting an adhesive injection tool through the top opening section of the through hole of the shaft along the axial direction, placing a tip of the adhesive injection tool adjacent to the male screw section of the screw member that is screwed in the through hole of the shaft, and injecting a predetermined amount of the adhesive in the through hole of the shaft.

7. A method for manufacturing a shaft member according to claim 5, further comprising allowing the adhesive to flow into the screw engagement section between the male screw section of the screw member and the female screw section of the shaft by capillary force and wetting spreadability of the adhesive generated at the screw engagement section between the male screw section of the screw member and the female screw section of the shaft.

8. A method for manufacturing a shaft member according to claim 7, wherein the adhesive has a controlled, viscosity that does not allow the adhesive to crawl up by wetting spreadability of the adhesive beyond a predetermined range along the female screw section of the shaft above the screw engagement section between the male screw section of the screw member and the female screw section of the shaft.

9. A method for manufacturing a shaft member according to claim 1, further comprising heating the adhesive after the coating, wherein the viscosity of the adhesive is maintained to be 5 Pa·s or higher after the coating and during the heating.

10. A method for manufacturing a shaft member according to claim 9, wherein the viscosity of the adhesive is maintained to be 25 Pa·s or lower during the coating and at least until the heating is started.

11. A method for manufacturing a dynamic pressure bearing device including a bearing member and a shaft member rotatably disposed with respect to one another, and a thrust plate mounted on the shaft member and a counter plate fixed to the bearing member disposed opposite to one another to compose a thrust dynamic pressure bearing section, the method comprising:
forming in the shaft member a through hole that communicates with both ends of the shaft member in an axial direction thereof;
forming a female screw section in an inner wall section of the through hole to allow male screw sections to be screwed from the both ends of the through hole of the shaft member;
screwing into the through hole of the shaft member a screw member with a screw head section and a male screw section extending from the screw head section for threaded engagement with the female screw section from one end of the shaft member;
interposing the thrust plate in the axial direction between the screw head section of the screw member and the one end of the shaft member; and
fixing the thrust plate to the shaft member by tightening force of the screw member.

12. A method for manufacturing a dynamic pressure bearing device according to claim 11, further comprising coating an adhesive to fill gaps in at least one part of a screw engagement section between the male screw section of the screw member and the female screw section of the shaft member to prevent lubrication fluid from leaking through the screw engagement section, wherein the adhesive has a viscosity of 5 Pa·s or higher all times after the coating.

13. A method for manufacturing a dynamic pressure bearing device according to claim 12, wherein the adhesive has a viscosity of 25 Pa·s or lower at least during the coating.

14. A method for method for manufacturing a dynamic pressure bearing device to claim 12, wherein the adhesive has a viscosity that allows the adhesive to spread along substantially an entire length of the male screw section of the screw member.

15. A method for method for manufacturing a dynamic pressure bearing device according to claim 11, further comprising holding the shaft generally vertically upright, and injecting the adhesive in the through hole of the shaft through a top opening section of the through hole of the shaft.

16. A method for method for manufacturing a dynamic pressure bearing device according to claim 15, further comprising inserting an adhesive injection tool through the top opening section of the through hole of the shaft along the axial direction, placing a tip of the adhesive injection tool adjacent to the male screw section of the screw member that is screwed in the through hole of the shaft, and injecting a predetermined amount of the adhesive in the through hole of the shaft.

17. A method for method for manufacturing a dynamic pressure bearing device according to claim 15, further comprising allowing the adhesive to flow into the screw engagement section between the male screw section of the screw member and the female screw section of the shaft by capillary force and wetting spreadability of the adhesive generated at the screw engagement section between the male screw section of the screw member and the female screw section of the shaft.

18. A method for method for manufacturing a dynamic pressure bearing device according to claim 17, wherein the adhesive has a controlled viscosity that does not allow the adhesive to crawl up by wetting spreadability of the adhesive beyond a predetermined range along the female screw section of the shaft above the screw engagement section between the male screw section of the screw member and the female screw section of the shaft.

19. A method for method for manufacturing a dynamic pressure bearing device according to claim 11, further comprising heating the adhesive after the coating, wherein the viscosity of the adhesive is maintained to be 5 Pa·s or higher after the coating and during the heating.

20. A method for method for manufacturing a dynamic pressure bearing device according to claim 12, further comprising heating the adhesive after the coating, wherein the viscosity of the adhesive is maintained to be 25 Pa·s or lower during the coating and at least until the heating is started.

21. A method for method for manufacturing a dynamic pressure bearing device according to claim 11, further comprising providing a space section where the thrust plate and the screw member join with each other to reduce the capillary force in the screw engagement section between the screw member and the shaft member to thereby prevent the adhesive from leaking outside, the adhesive is well prevented from leaking outside when it is injected.
